(19) United States
(12) Patent Application Publication
(10) Pub. No.: US 2009/0006712 A1
(43) Pub. Date: Jan. 1, 2009

(54) DATA ORDERING IN A MULTI-NODE SYSTEM

(76) Inventors: FATMA EHSAN, Friends Colony (IN); Binata Bhattacharyya, Brookefield (IN); Namratha Jaisimha, Bangalore (IN); Liang Yin, San Jose, CA (US)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 11/772,062

(22) Filed: Jun. 29, 2007

(51) Int. Cl. G06F 12/00

(52) U.S. Cl. 711/1

(57) ABSTRACT

Methods and apparatuses for data ordering in a multi-node system that supports non-snoop memory transactions.

### TECHNICAL FIELD

Embodiments of the invention relate to techniques for data management including data ordering. More particularly, embodiments of the invention relate to techniques for ensuring that the most recent data in a multi-node system is updated to memory while multiple conflicting evictions are properly processed in a multi-node system having point-to-point connections between the nodes.

### BACKGROUND

A multi-node system is one in which multiple nodes are interconnected to function as a single system. A node may be any type of data source or sink, for example, a processor or processing core, or a memory controller with associated memory. Because each node may modify and/or provide data to other nodes in the system, data coherency including cache coherency is important. However, as the number of nodes increases, the complexity of the coherency may increase.

### BRIEF DESCRIPTION OF THE DRAWINGS

Embodiments of the invention are illustrated by way of example, and not by way of limitation, in the figures of the accompanying drawings in which like reference numerals refer to similar elements.

FIG. 1a is a block diagram of one embodiment of electronic system having a processor core, a memory controller and a memory that may utilize point-to-point interfaces.

FIG. 1b is a block diagram of one embodiment of electronic system having a processor core, a memory and an I/O controller hub that may utilize point-to-point interfaces.

FIG. 1c is a block diagram of one embodiment of electronic system having an I/O controller hub coupled with two processor cores each having a memory that may utilize point-to-point interfaces.

FIG. 2 is a block diagram of one embodiment of an architecture for ordering data transactions in a multi-node system.

FIG. 3 is a block diagram of one embodiment of an architecture that may utilize a data ordering technique as described herein.

FIG. 4 is a block diagram of one embodiment of an apparatus for a physical interconnect.

FIG. 5 is a block diagram indicating movement of data within one embodiment of an architecture that supports data ordering.

FIG. 6 is one embodiment of a signal flow diagram corresponding to the architectures described herein.

### DETAILED DESCRIPTION

In the following description, numerous specific details are set forth. However, embodiments of the invention may be practiced without these specific details. In other instances, well-known circuits, structures and techniques have not been shown in detail in order not to obscure the understanding of this description.

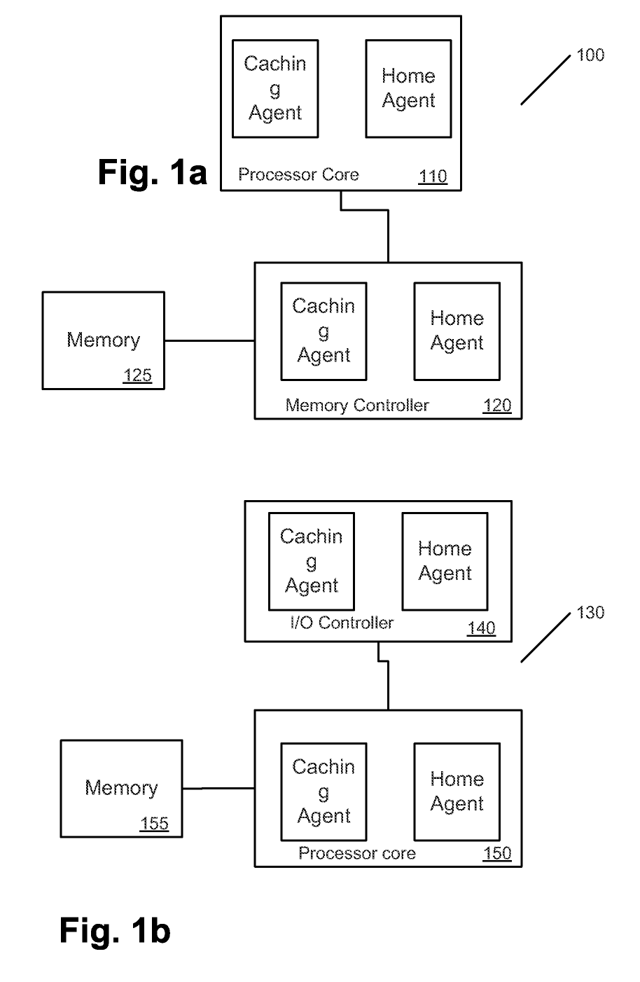

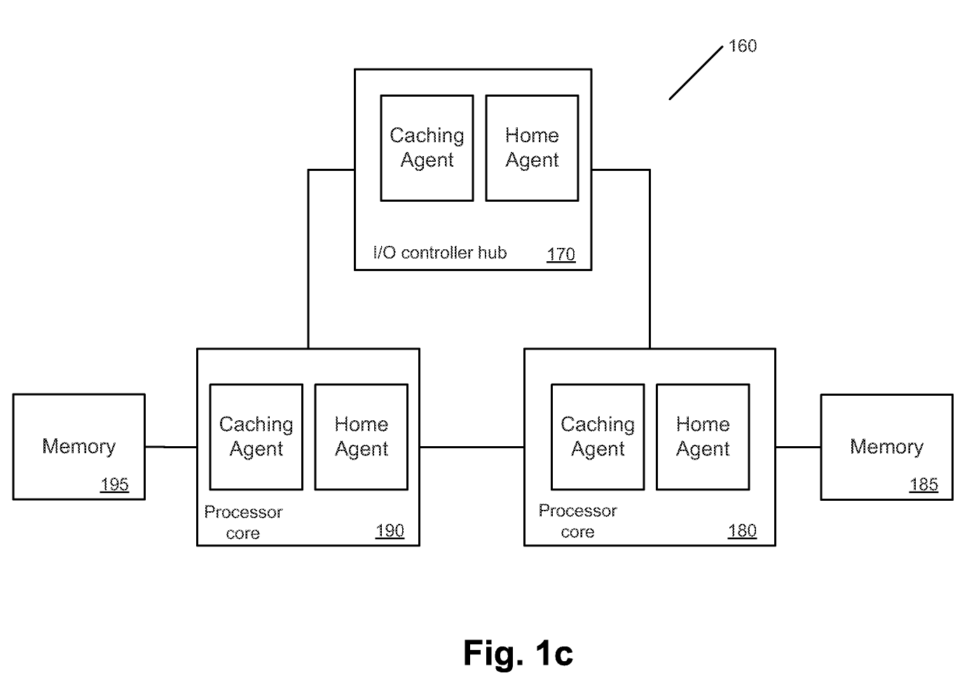

FIGS. 1a through 1c are block diagrams of simple multi-node systems that may utilize the data ordering techniques described herein. However, the data ordering techniques described herein may be applied to multi-node systems of far greater complexity. In general, each node includes a caching agent (e.g., at least one cache memory and cache controller) and a home agent. The caching agent may receive deferred local read and write requests/transactions for memory accesses and also responses from snoops originated on behalf of requests from other caching agents in the system. The home agent may return the requested data while resolving access conflicts and maintaining memory coherence across the multi-node system.

FIG. 1a is a block diagram of one embodiment of electronic system having a processor core, a memory controller and a memory that may utilize point-to-point interfaces. Additional components not illustrated in FIG. 1a may also be supported.

Electronic system 100 may include processor core 110 and memory controller 120 that are coupled together with a point-to-point interface. Memory controller 120 may also be coupled with memory 125, which may be any type of memory including, for example, random access memory (RAM) of any type (e.g., DRAM, SRAM, DDRAM).

FIG. 1b is a block diagram of one embodiment of electronic system having a processor core, a memory and an I/O controller hub that may utilize point-to-point interfaces. Additional components not illustrated in FIG. 1b may also be supported.

Electronic system 130 may include processor core 150 and I/O controller hub 140 that are coupled together with a point-to-point interface. Processor core 150 may also be coupled with memory 155, which may be any type of memory including, for example, random access memory (RAM) of any type (e.g., DRAM, SRAM, DDRAM).

FIG. 1c is a block diagram of one embodiment of electronic system having an I/O controller hub coupled with two processor cores each having a memory that may utilize point-to-point interfaces. Additional components not illustrated in FIG. 1c may also be supported.

Electronic system 160 may include two processor cores 180, 190 and I/O controller hub 170 that are coupled together with point-to-point interfaces. Processor cores 180, 190 may also be coupled with memories 185, 195, which may be any type of memory including, for example, random access memory (RAM) of any type (e.g., DRAM, SRAM, DDRAM).

Under certain conditions handling of writeback operations may leave an exclusive state copy of data in a cache hierarchy, which may require multiple writeback operations to a single location in memory. This may result in an inefficient use of system resources. As described herein, multiple writeback operations to the same memory location may be merged in the caching agent before being sent to memory. In one embodiment, when conflicting write operations are merged both the data and the command packets are merged and the latest data is sent to memory. This merging is made more complex in a system having independent command and data paths.

In a system having independent data and command paths when a data request is outstanding in the caching agent, another data write or response may hit the same address. Ordering of the transactions may be maintained by the caching agent by, for example, the techniques and/or structures described below.

As described herein subsequent data transactions may overwrite preceding data transactions if the preceding data transaction is not out of the caching agent. Otherwise, the later data transaction may wait in the caching agent until the previous write is completed and the subsequent data transaction is issued by the caching agent along with the corresponding data so that the memory location is updated by the latest data and stale data does not overwrite the latest data.

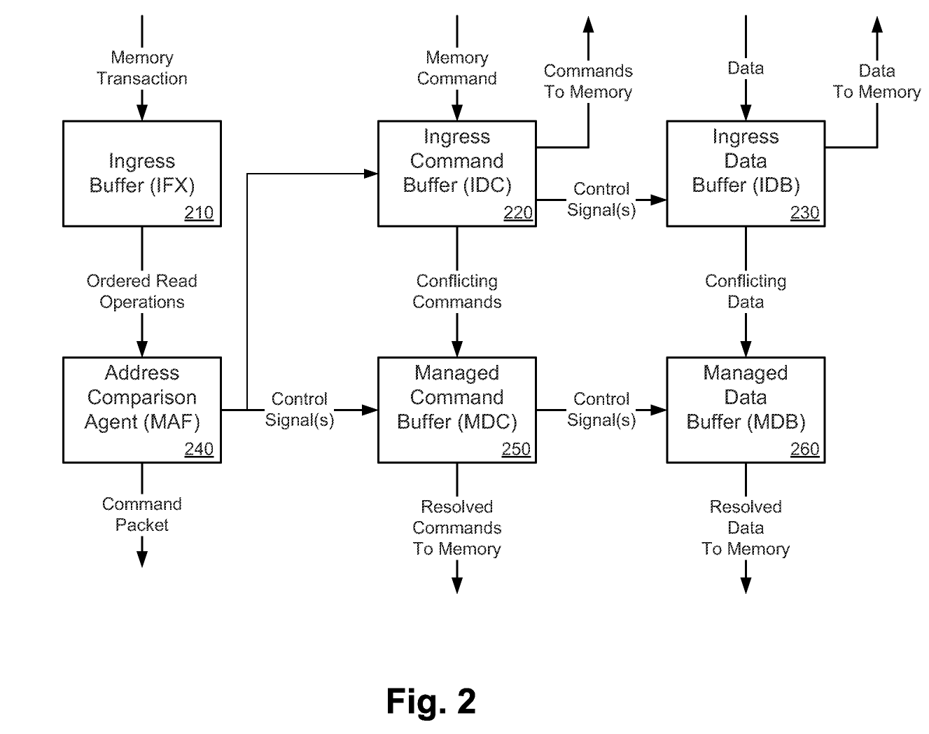

FIG. 2 is a block diagram of one embodiment of an architecture for ordering data transactions in a multi-node system. The architecture of FIG. 2 will be described in terms of an example in which three writeback operations are directed to the same memory location and are received by the node caching agent in the following order: i) writeback0, command C0 with data D0, ii) writeback1, command C1 with data D1, and iii) writeback2, command C2 with data D2. While the example includes three writeback operations, any number of writeback operations may be supported using the techniques described herein.

Memory transaction writeback0 may be received by command C0 being stored in ingress buffer 210 and data D0 being stored in ingress data buffer 230. Command C0 may be issued to address comparison agent 240 for comparison against pending memory transactions. In one embodiment, address comparison agent 240 may include a content addressable memory (CAM) that may be used for comparison purposes. Command C0 may also be stored in ingress command buffer 220.

Memory transaction writeback1 may then be received by command C1 being stored in ingress buffer 210 and data D1 being stored in ingress data buffer 230. Command C0 may then be allocated in address comparison agent 240 and sent to memory as a writeback operation. In one embodiment, the writeback operation may cause the state of the associated data to change from modified (M) to exclusive (E). This may be referred to as a “WbMtoE(0) command. Also, data D0 may be moved from ingress data buffer 230 to managed data buffer 260, which may function as a data buffer for address comparison agent 240. The data may be sent to memory in association with the writeback operation. This may be referred to as a “WbEData(0)” operation.

Next, command C1 may be issued from ingress buffer 210 to address comparison agent 240 where it may be merged with command C0. At this point, data D1 may still be in ingress data buffer 230. Command C2 may then be received by ingress buffer 210 by command C2 being stored in ingress buffer 210 and data D2 being stored in ingress data buffer 230.

When received by address comparison agent 240, command C2 may be merged with the previously merged command C0/C1. In one embodiment, data D1 and data D2 may be arbitrated by ingress data buffer 230 to be moved to managed data buffer 260. If, for example, data D2 wins the arbitration, data D2 may be moved to managed data buffer 260 and overwrite data D0. Data D1 may be maintained in ingress data buffer 230 and ready to be moved to managed data buffer 260.

Next, data D1 may win arbitration in ingress data buffer 230 to be moved to managed data buffer 260. However, data D1 may not be written to managed data buffer 260 because the latest data (D2) is already available in managed data buffer 260.

The home agent may then send a completion message (Cmp) for command C0. Then merged command C1/C2 may be sent to memory as a writeback command. This may be referred to as “WbMtoE(1).” Data D2 may go to the caching agent as a “WbEData(1)” command to cause data D1 to be written to memory. The home agent may then receive the latest data that is compatible with the requirement to maintain system coherence.

In one embodiment, a state machine may be utilized to maintain data ordering for conflicting evictions (WbMtoE operations). The following basis may be utilized for the state machine.

Request allocations from ingress buffer 210 to address comparison agent 240 may be performed in order. When a write request is allocated by address comparison agent 240, the allocated entry information may be stored in ingress command buffer 220 and the corresponding data may be stored in ingress data buffer 230. When a request is allocated in address comparison agent 240, control signals may be sent to ingress command buffer 220 and to managed command buffer 250. This control signals may indicate whether command/data is ready to move, whether the command/data should be moved, whether the command/data should be merged, etc.

In one embodiment, ingress command buffer 220 may receive an allocated entry number from address comparison agent 240 for each entry. This entry number may be used to generate a signal to indicate whether the latest data is available in managed data buffer 260 for each entry in managed data buffer 260. This may indicate that the data in managed data buffer 260 for a particular entry is the latest and there is no more recent data in ingress data buffer 230 to be moved to managed data buffer 260.

In one embodiment, ingress command buffer 220 may maintain an index for entries in ingress data buffer 230 that store data corresponding to entries in merged address comparison agent 240. In one embodiment, the state machine may not allow data for merged entries to be moved from ingress data buffer 230 to managed data buffer 260 unless the data is the latest data. This may be communicated via one or more control signals. The state machine may also ensure that the data in the manage data buffer entries are not overwritten with data that is not the latest data. A control signal may be utilized because the data move from ingress data buffer 230 to managed data buffer 260 may be out of order due to, for example, arbitration logic in ingress command buffer 220.

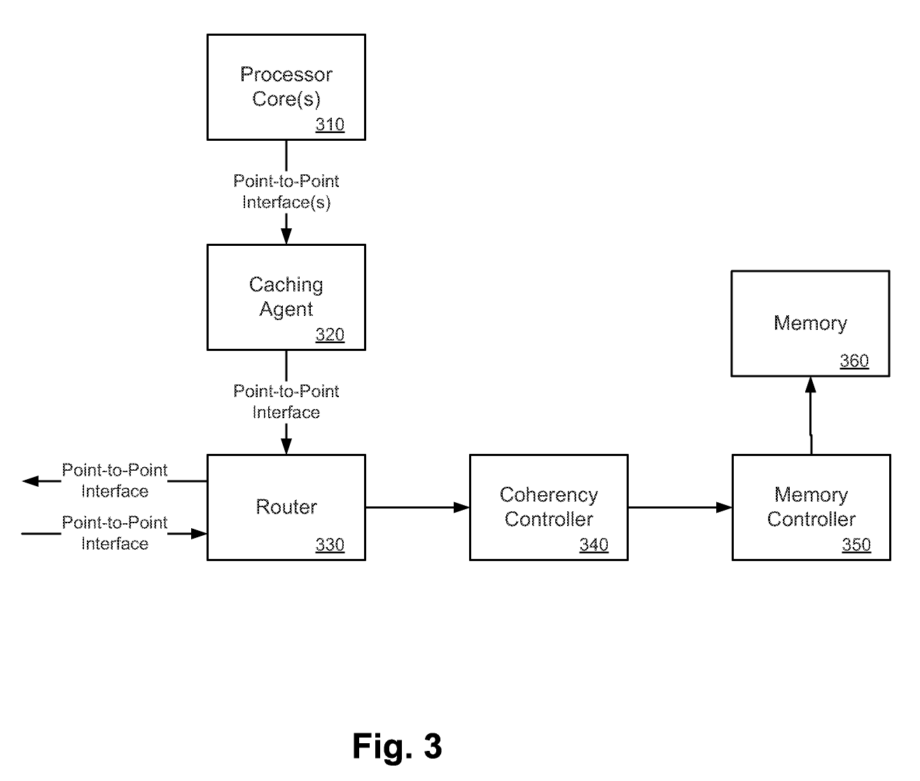

FIG. 3 is a block diagram of one embodiment of an architecture that may utilize a data ordering technique as described herein. The architecture of FIG. 3 is but one example of the type of architecture that may utilize data ordering as described herein.

One or more processing cores 310 may be coupled with caching agent 320 via one or more pairs of point-to-point links. As used herein a processing core refers to the processing portion of a processor chip minus cache memory/memories. That is, the processing core includes a control unit and an arithmetic logic unit (ALU) as well as any necessary supporting circuitry. Multiple processing cores may be housed within a single integrated circuit (IC) package. Various configurations of processing cores are known in the art. Any type of point-to-point interface known in the art may be utilized.

In one embodiment, caching agent 320 may include the components described with respect to FIG. 2. In alternate embodiments, caching agent 320 may include one or more of the components described with respect to FIG. 2 with the remaining components outside of caching agent 320, but interconnected as illustrated in FIG. 2.

In one embodiment, the components of FIG. 3 may be connected within a larger system via a socket or other physical interface. Use of sockets may allow for more flexibility in system design than other configurations. In one embodiment, router 330 allows communication between the components of FIG. 3 and other, remote sockets (not illustrated in FIG. 3). In one embodiment, router 330 communicates with remote sockets via one or more point-to-point links.

Caching agent 320 and remote sockets may communicate with coherence controller 340. Coherence controller 340 may implement any cache coherency protocol known in the art. Coherence controller 340 may be coupled with memory controller 350, which may function to control memory 360.

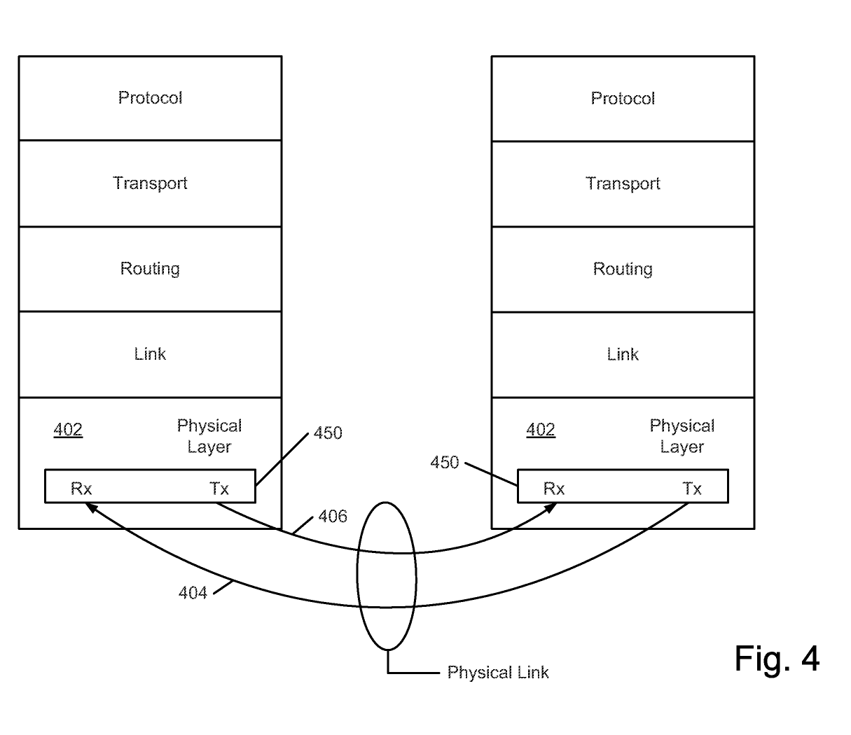

FIG. 4 is a block diagram of one embodiment of an apparatus for a physical interconnect. In one aspect, the apparatus depicts a physical layer for a cache-coherent, link-based interconnect scheme for a processor, chipset, and/or IO bridge components. For example, the physical interconnect may be performed by each physical layer of an integrated device.

Specifically, the physical layer may provide communication between two ports over a physical interconnect comprising two uni-directional links. Specifically, one uni-directional link 404 from a first transmit port 450 of a first integrated device to a first receiver port 450 of a second integrated device. Likewise, a second uni-directional link 406 from a first transmit port 450 of the second integrated device to a first receiver port 450 of the first integrated device. However, the claimed subject matter is not limited to two uni-directional links.

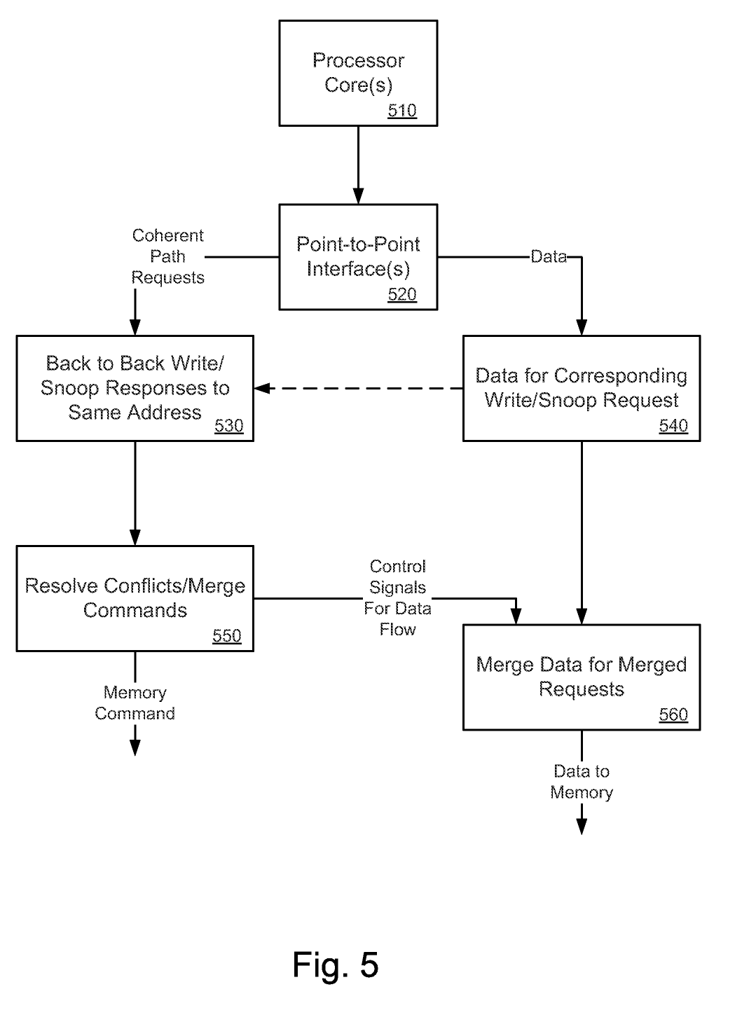

FIG. 5 is a block diagram indicating movement of data within one embodiment of an architecture that supports data ordering. Processing core(s) 510 may be any type of processing circuitry that may produce and/or consume data. Processing core(s) 510 may transfer data via one or more point-to-point interfaces 520.

As described in greater detail above, commands and data corresponding to memory requests may be processed by different components at different times. In one embodiment, memory requests corresponding to the same address in memory may be ordered as described above. These memory requests, 530, may be analyzed and, if necessary, merged, 550.

The data corresponding to the memory request, 540, may be stored and/or processed by different components than the request. In one embodiment, the architecture described with respect to FIG. 2 may be utilized. If necessary, the data may be merged, 560 to support corresponding merged memory requests. In one embodiment, the merged data, 560, is always the most recent data to be written to the address so that proper data ordering is maintained. Once the conflicts are resolved and the commands and/or data merged, the resulting data may be written to memory.

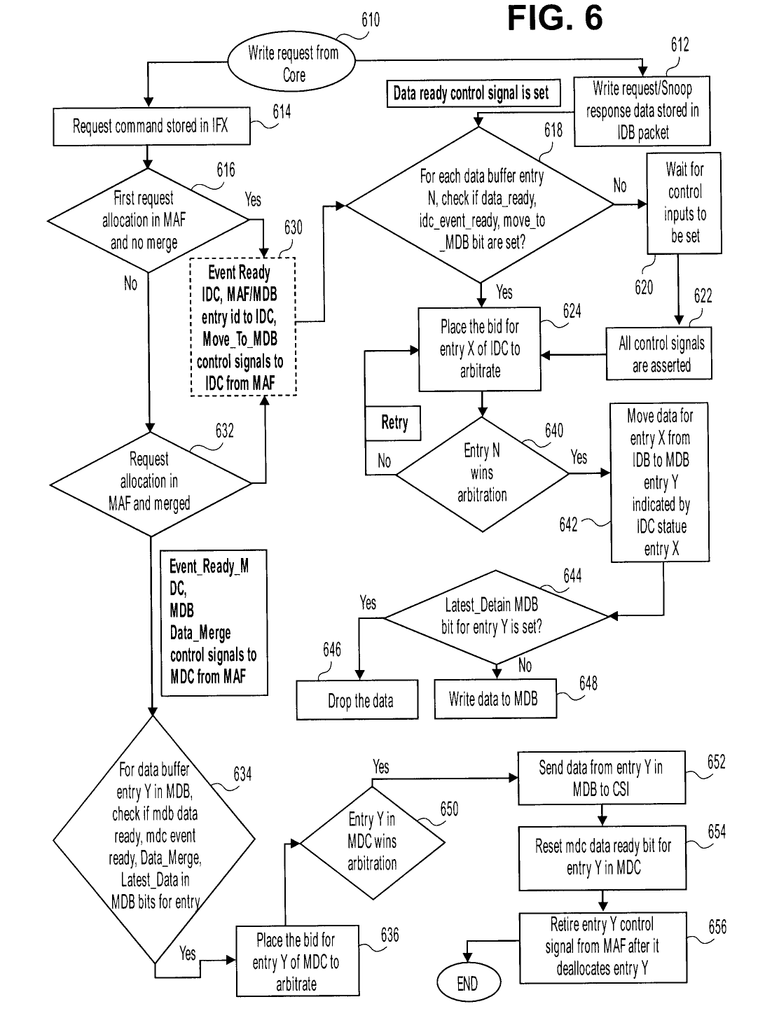

FIG. 6 is one embodiment of a signal flow diagram corresponding to the architectures described herein. The example of FIG. 6 corresponds to receiving a write request from a processor core, 610. In response to receiving the write request, the command is stored in the ingress buffer, 614. The write request and/or snoop response data is also stored in an ingress data buffer packet, 612.

Returning to the ingress command buffer, if the request is the first request allocation to the address comparison agent, 616, an event ready command having an address comparison agent entry identifier and/or a managed data buffer entry identifier may be generated and sent to the ingress command buffer, 630. In one embodiment, a signal to cause the corresponding entry to be sent to the ingress command buffer may be generated/asserted/transmitted.

If the request is not the first request allocation in the address comparison agent, 616, the request allocation in the address comparison agent is merged with the new request, 632. After the merger, an event ready command having an address comparison agent entry identifier and/or a managed data buffer entry identifier may be generated and sent to the ingress command buffer, 630.

For a data buffer entry in the managed data buffer, the system may check whether the managed data buffer data is ready, the managed command buffer event is ready and/or the data merger in the managed data buffer has been completed, 634. If so, the address comparison agent (or other component) may place a bid for entry to the managed command buffer for arbitration, 636.

If the entry does not win the arbitration, 650, the bid may be retried, 636. If the entry does win the arbitration, 650, the data entry from the managed data buffer is sent to an output buffer that may transmit the entry to, for example, a memory, 652. The managed command buffer data is reset, 654. The entry is retired and deallocated, 656.

Returning to the write request/snoop response in the ingress data buffer, 612, for each data buffer entry, the system may check to determine whether the command entry and corresponding data entry are ready to move to the managed buffers, 618. If so, a bid is placed for entry into the ingress command buffer for arbitration, 624. If not, with for the appropriate control signals to be set, 620, and asserted, 622.

If the entry does not win arbitration, 640, the bid is retried, 624. If the entry does win arbitration, 640, the data entry is moved from the ingress data buffer to the managed data buffer, 642. If the entry corresponds to the latest data, 644, the data is moved to the managed data buffer, 648. If the data is not the latest data, 644, the data is dropped, 646.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

While the invention has been described in terms of several embodiments, those skilled in the art will recognize that the invention is not limited to the embodiments described, but can be practiced with modification and alteration within the spirit and scope of the appended claims. The description is thus to be regarded as illustrative instead of limiting.

What is claimed is:

1. An apparatus comprising:
an ingress command buffer to store commands corresponding to one or more memory access requests;
an ingress data buffer to store data corresponding to the one or more memory access requests;
an address comparison agent to compare target addresses for the one or more memory access requests;
a command buffer coupled with the ingress command buffer and the address comparison agent to store commands corresponding to conflicting memory access requests, wherein two or more of the conflicting requests are merged into a single, merged memory access request; and
a data buffer coupled with the ingress command buffer and the address comparison agent to store data corresponding to the conflicting memory access requests, wherein most recent data from the conflicting memory access requests is stored in association with the merged memory access request and stale data corresponding to conflicting memory access requests is dropped.

2. The apparatus of claim 1, wherein non-conflicting memory access requests stored in the ingress command buffer cause corresponding data stored in the ingress data buffer to be written to memory.

3. The apparatus of claim 1 further comprising a point-to-point interface configured to carry the memory access requests from a processing core.

4. The apparatus of claim 3 further comprising a router to carry memory requests form one or more remote processing cores.

5. A system comprising:
an ingress command buffer to store commands corresponding to one or more memory access requests;
an ingress data buffer to store data corresponding to the one or more memory access requests;
an address comparison agent to compare target addresses for the one or more memory access requests;
a command buffer coupled with the ingress command buffer and the address comparison agent to store commands corresponding to conflicting memory access requests, wherein two or more of the conflicting requests are merged into a single, merged memory access request;
a data buffer coupled with the ingress command buffer and the address comparison agent to store data corresponding to the conflicting memory access requests, wherein most recent data from the conflicting memory access requests is stored in association with the merged memory access request; and
a dynamic random access memory (DRAM) coupled to the ingress command buffer, the command buffer, the ingress data buffer and the data buffer.

6. The system of claim 5, wherein non-conflicting memory access requests stored in the ingress command buffer cause corresponding data stored in the ingress data buffer to be written to the DRAM.

7. The system of claim 6 wherein the non-conflicting memory access requests and corresponding data are written to memory after being stored in the command buffer and the data buffer, respectively.

8. The system of claim 5 further comprising a point-to-point interface configured to carry the memory access requests from a processing core.

9. The system of claim 8 further comprising a router to carry memory requests form one or more remote processing cores.

10. A method comprising:
receiving a plurality of memory access requests including at least two memory access requests to a same memory address;
analyzing the plurality of memory access requests to identify the at least two memory access requests to the same memory address to indicate a conflict;
storing commands corresponding to memory access requests for which a conflict has not been identified in a first command buffer;
storing commands corresponding to memory accesses requests for which a conflict has been identified in a second command buffer; and
merging two or more memory access requests for which a conflict has been identified.

11. The method of claim 10 further comprising:
storing data corresponding to memory access requests for which a conflict has not been identified in a first data buffer;
storing data corresponding to memory accesses requests for which a conflict has been identified in a second data buffer; and
associating the merged memory access requests with a most recent data value from the memory access requests for which a conflict has been identified.

12. The method of claim 11, wherein non-conflicting memory access requests stored in the first command buffer cause corresponding data stored in the first data buffer to be written to memory.

13. The method of claim 12 wherein the non-conflicting memory access requests and corresponding data are written to memory after being stored in the second command buffer and the second data buffer, respectively.

14. The method of claim 11 further comprising receiving at least one of the memory access requests via a point-to-point interface configured to carry the memory access requests from a processing core.

15. The method of claim 14 further comprising receiving at least one of the memory access requests via a router to carry memory requests form one or more remote processing cores.

16. An apparatus comprising:
means for receiving a plurality of memory access requests including at least two memory access requests to a same memory address;
means for the plurality of memory access requests to identify the at least two memory access requests to the same memory address to indicate a conflict;
means for storing commands corresponding to memory access requests for which a conflict has not been identified in a first command buffer;
means for storing commands corresponding to memory accesses requests for which a conflict has been identified in a second command buffer; and
means for merging two or more memory access requests for which a conflict has been identified.

17. The apparatus of claim 16 further comprising:
means for storing data corresponding to memory access requests for which a conflict has not been identified in a first data buffer;
means for storing data corresponding to memory accesses requests for which a conflict has been identified in a second data buffer; and
means for associating the merged memory access requests with a most recent data value from the memory access requests for which a conflict has been identified.

18. The apparatus of claim 17 further comprising means for receiving at least one of the memory access requests via a point-to-point interface configured to carry the memory access requests from a processing core.

19. The apparatus of claim 18 further comprising receiving at least one of the memory access requests via a router to carry memory requests form one or more remote processing cores.
